(19) United States
(12) Patent Application Publication
(10) Pub. No.: US 2021/0024799 A1
(43) Pub. Date: Jan. 28, 2021

(54) STRUCTURED ABRASIVES CONTAINING POLISHING MATERIALS FOR USE IN THE HOME

(71) Applicant: 3M INNOVATIVE PROPERTIES COMPANY, St. Paul, MN (US)

(72) Inventors: Irem Bolukbasi, St. Paul (MN); Yifan Zhang, Woodbury, MN (US); Kyle C. Bryson, Maplewood, MN (US)

(21) Appl. No.: 16/982,205

(22) PCT Filed: Mar. 21, 2019
(86) PCT No.: PCT/IB2019/052303

§ 371 Date: Sep. 18, 2020

Related U.S. Application Data
(60) Provisional application No. 62/646,079, filed on Mar. 21, 2018.

(51) Int. Cl. C09K 3/14

(52) U.S. Cl. CPC C09K 3/1436

(57) ABSTRACT

The present invention is an abrasive agglomerate. The abrasive agglomerate includes between about 8 and about 50 wt % cerium oxide, between about 5 and about 75 wt % filler, and a curable, polymeric binder resin.

### FIELD OF THE INVENTION

The present invention is related to the field of abrasives. In particular, the present invention is a fixed abrasive for polishing glass and glass-ceramic surfaces.

### BACKGROUND

A common practice in the field of polishing glass surfaces is to use fixed abrasives having very high concentrations of ceria (up to about 80 wt %). Ceria is a hard mineral with a Mohs hardness (about 6) comparable to that of glass (about 6-7). Due in part to the fact that ceria and glass have very comparable levels of hardness, ceria is very effective in polishing glass surfaces without scratching the glass. However, due to the relatively high hardness of ceria, if highly ceria-filled abrasives are inadvertently used to scour common delicate surfaces in kitchens other than glass surfaces, such as certain metal and polymer surfaces, these abrasives may cause extensive scratching and damage. One way to prevent scratching when an abrasive is used on non-intended surfaces is to reduce the ceria concentration in the abrasive. However, while the reduced ceria concentration may reduce the extent of non-glass surface damage, the reduced ceria concentration will also reduce the performance and effectiveness of the abrasive on intended glass surfaces.

One method to reduce the amount of ceria in an abrasive while still being able to effectively scour and polish glass is suggested by Lugg et al. in U.S. Publ. 2016/022 1146 titled “COMPOSITE CERAMIC ABRASIVE POLISHING SOLUTION” to 3M Company, St. Paul, Minn. Lugg et al. propose providing a polishing solution which includes a fluid component and a plurality of ceramic abrasive composites having pH modifiers. Lugg et al. teach that, due to the synergistic effects between ceria, pH modifiers, and glass surface, a ceria concentration of only 6.5 wt % is enough to obtain satisfactory performance. Note that Lugg et al. teach this approach primarily for industrial cleaning and polishing applications. However, polishing solutions are inherently unwieldy when used by ordinary consumers in consumer cleaning and polishing applications. One reason is that the use of polishing solutions requires additional clean-up, wiping, and/or rinsing steps, which are time consuming. Second, polishing solutions may contain chemicals which may be irritants and/or hazardous to humans upon inhalation, skin contact, and/or eye contact. Thus, because many ordinary consumers do not wear personal protective equipment and because many ordinary kitchens are not equipped with engineering controls which are customary in industrial sites, polishing solutions may be impractical or unsafe to be used in consumer applications.

### SUMMARY

In one embodiment, the present invention is an abrasive agglomerate. The abrasive agglomerate includes between about 8 and about 50 wt % cerium oxide, between about 5 and about 75 wt % filler, and a curable, polymeric binder resin.

In another embodiment, the present invention is a fixed abrasive including a backing and an abrasive agglomerate fixed to the backing. The abrasive agglomerate includes between about 8 and about 50 wt % cerium oxide, between about 5 and about 75 wt % filler, and a curable, polymeric binder resin.

### DETAILED DESCRIPTION

The present invention is an abrasive agglomerate having a limited cerium oxide content and a high filler content. When the abrasive agglomerate is incorporated into a medium to form a fixed abrasive, such as a cleaning pad, the fixed abrasive can efficiently polish glass surfaces without scratching the surface. In addition, when used on glass surfaces, the fixed abrasive can also remove some scratches by polishing the surface. While the specification primarily refers to the surface being cleaned as a glass surface, the abrasive agglomerate and fixed abrasive can also be effectively used on any surface having a greater hardness than glass without departing from the intended scope of the present invention. Furthermore, the use of the phrase “glass surface” in this specification also refers to any surface of a hard, glassy nature, such as glass-ceramic surfaces.

The abrasive agglomerate of the present invention generally includes cerium oxide, filler, and a curable, polymeric binder resin. As used herein, the term “abrasive agglomerate” refers to the entire abrasive material, including the abrasive, binder, and any additives. Cerium oxide, or ceria, is a hard, rare earth compound, allowing it to abrade and polish a number of surfaces without the need for a polishing solution. It is believed that ceria may provide a chemical-mechanical element to the polishing procedure. As used herein, chemical-mechanical refers to a dual mechanism where corrosion chemistry and fracture mechanics both play a role in glass polishing. Thus, ceria acts as both a mechanical abrasive and a chemical reactant with glass surfaces, achieving chemical-mechanical polishing of glass. In particular, it is believed that the cerium oxide provides a chemical element to the polishing phenomenon as discussed in Cook, L. M., “Chemical Processes in Glass Polishing”, 120 Journal of Non-Crystalline Solids 152-171, Elsevier Science Publ. B.V. (1990). The abrasive agglomerate of the present invention is unique in that it includes a limited amount of ceria, while still efficiently removing common household soils from surfaces and depending on the specific hardness of the ceramic oxide used in the abrasive agglomerate, the abrasive agglomerate can also effectively polish the surface being cleaned without scratching the surface. In one embodiment, the abrasive agglomerate of the present invention includes between about 8 and about 50 wt % ceria, particularly between about 10 and about 25 wt % ceria, and more particularly between about 12 and about 20 wt % ceria.

The filler is used to form an agglomerate. The filler of the present invention can be any solid containing metal ions that will not scratch glass and that can be solubilized to some extent by water and leach out of the abrasive agglomerate or out of dust formed from use of the abrasive agglomerate as an abrasive. The filler has dual functionality in the abrasive agglomerate and fixed abrasive of the present invention. First, it is a soft mineral, which reduces the overall hardness of the abrasive agglomerate and thus, provides an abrasive agglomerate which will cause less damage if used on unintended, but anticipated surfaces by consumers. Second, and without being bound by theory, it is anticipated that metal ions leach out from the abrasive agglomerate during polishing and act as pH modifiers which in turn facilitates synergistic interactions between the abrasive agglomerate and a glass surface, thus increasing the polishing performance. Thus, it is the synergistic combination of the ceria with the metal ions from the filler that allows the abrasive agglomerate of the present invention to effectively polish glass surfaces at lower cerium oxide concentrations. Examples of suitable fillers include, but are not limited to: salts of group II metals or transition metals that have some solubility in tap water, for example sulfate, chloride, acetate, or carbonate salts of calcium. In one embodiment, the filler is calcium carbonate. In one embodiment, the abrasive agglomerate of the present invention includes between about 5 and about 75 wt % filler, particularly between about 20 and about 60 wt % filler, and more particularly between about 35 and about 50 wt % filler.

The particle size of the calcium carbonate seems to be important in two ways: how it affects the viscosity of the slurry before curing, and how it affects the breakdown of the cured fixed abrasive during use. Larger particles generally provide less viscosity increase than small particles at a given particle loading, and larger particles lead to more rapid breakdown of the fixed abrasive, whereas very small calcium carbonate particles can actually strengthen the fixed abrasive. Thus, the particle size or mixture of particle sizes used will depend on the manufacturing process and the desired properties of the fixed abrasive.

Other materials can be added to the abrasive agglomerate for special purposes, including, but not limited to: coupling agents, photoinitiators, thermal initiators, viscosity modifiers, adhesion promoters, grinding aids, wetting agents, dispersing agents, light stabilizers, antioxidants, anti-foam agents, microbiocidal agents, dyes, pigments, and fragrances. An example of a suitable coupling agent includes, but is not limited to, 3-(trimethoxysilyl)propyl methacrylate silane. A dispersant can be used to enhance the wetting and dispersing speed of the filler, metal oxides, and other minerals in the abrasive. Examples of suitable dispersants include, but are not limited to: acid polyesters, acid phosphate polyesters, and amine-terminated polyester polymers.

The polymeric binder resin is used to bind the cerium oxide minerals. This is generally accomplished by dispersing the cerium oxide minerals and the filler in a binder precursor, usually in the presence of an appropriate curative (e.g., photoinitiator, thermal curative, and/or catalyst). In one embodiment, the binder precursor has sufficient flowability so as to be able to coat a surface.

The binder precursor may be an organic solvent borne, a water-borne, or a 100-percent-solids (i.e., substantially solvent-free) composition. Both thermoplastic and/or thermosetting polymers, or materials, as well as combinations thereof, may be used as binder precursors in the present invention. Upon curing of the binder precursor, the curable coating is converted into a cured bond system. Examples of suitable polymeric binders include, but are not limited to: phenolics, aminoplasts, urethanes, epoxies, acrylics, cyanates, isocyanurates, glue, and combinations thereof.

There are two main classes of polymerizable resins that may be included in the binder precursor, condensation polymerizable resins and addition polymerizable resins. Addition polymerizable resins are advantageous because they are readily cured by exposure to radiation energy. Addition polymerized resins can polymerize, for example, through a cationic mechanism or a free-radical mechanism. Depending upon the energy source that is utilized and the binder precursor chemistry, a curing agent, initiator, or catalyst may be useful to help initiate the polymerization. Examples of typical binder precursors include, but are not limited to: phenolic resins, urea-formaldehyde resins, aminoplast resins, urethane resins, melamine formaldehyde resins, cyanate resins, isocyanurate resins, (meth)acrylate resins (e.g., (meth)acrylated urethanes, (meth)acrylated epoxies, ethylenically-unsaturated free-radically polymerizable compounds, aminoplast derivatives having pendant alpha, beta-unsaturated carbonyl groups, isocyanurate derivatives having at least one pendant acrylate group, and isocyanate derivatives having at least one pendant acrylate group) vinyl ethers, epoxy resins, and mixtures and combinations thereof. As used herein, the term “(meth)acryl” encompasses acryl and methacryl.

Phenolic resins have good thermal properties, availability, and relatively low cost and ease of handling. There are two types of phenolic resins, resole and novolac. Resole phenolic resins have a molar ratio of formaldehyde to phenol of greater than or equal to one to one, typically in a range of from 1.5:1.0 to 3.0:1.0. Novolac resins have a molar ratio of formaldehyde to phenol of less than one to one. Examples of commercially available phenolic resins include, but are not limited to, those known by the trade designations DUREZ and VARCUM from Occidental Chemicals Corp. of Dallas, Tex.; RESINOX from Monsanto Co. of Saint Louis, Mo.; and AEROFENE and AROTAP from Ashland Specialty Chemical Co. of Dublin, Ohio.

(Meth)acrylated urethanes include di(meth)acrylate esters of hydroxyl-terminated NCO extended polyesters or polyethers. Examples of commercially available acrylated urethanes include those available as CMD 6600, CMD 8400, and CMD 8805 from Cytec Industries of West Paterson, N.J. (Meth)acrylated epoxies include di(meth)acrylate esters of epoxy resins such as the diacrylate esters of bisphenol A epoxy resin. Examples of commercially available acrylated epoxies include, but are not limited to, those available as CMD 3500, CMD 3600, and CMD 3700 from Cytec Industries.

Ethylenically-unsaturated free-radically polymerizable compounds include both monomeric and polymeric compounds that contain atoms of carbon, hydrogen, and oxygen, and optionally, nitrogen and the halogens. Oxygen or nitrogen atoms or both are generally present in ether, ester, urethane, amide, and urea groups. Ethylenically-unsaturated free-radically polymerizable compounds typically have a molecular weight of less than about 4,000 g/mole and are typically esters made from the reaction of compounds containing a single aliphatic hydroxyl group or multiple aliphatic hydroxyl groups and unsaturated carboxylic acids, such as acrylic acid, methacrylic acid, itaconic acid, crotonic acid, isocrotonic acid, maleic acid, and the like.

Representative examples of (meth)acrylate resins include, but are not limited to: methyl methacrylate, ethyl methacrylate styrene, divinylbenzene, vinyl toluene, ethylene glycol diacrylate, ethylene glycol methacrylate, hexanediol diacrylate, triethylene glycol diacrylate, trimethylolpropane triacrylate, glycerol triacrylate, pentaerythritol triacrylate, pentaerythritol methacrylate, pentaerythritol tetraacrylate and pentaerythritol tetraacrylate. Other ethylenically unsaturated resins include, but are not limited to: monoallyl, polyallyl, and polymethallyl esters and amides of carboxylic acids, such as diallyl phthalate, diallyl adipate, and N,N-diallyladipamide. Still other nitrogen containing compounds include tris(2-acryloyl-oxyethyl) isocyanurate, 1,3,5-tris(2-methyacryloxyethyl)-s-triazine, acrylamide, N-methylacrylamide, N,N-dimethylacrylamide, N-vinylpyrrolidone, and N-vinylpiperidone. Useful aminoplast resins have at least one pendant alpha, beta-unsaturated carbonyl group per molecule or oligomer. These unsaturated carbonyl groups can be acrylate, methacrylate, or acrylamide type groups. Examples of such materials include, but are not limited to: N-(hydroxymethyl)acrylamide, N,N′-oxydimethylenebisacrylamide, ortho- and paraacrylamidomethylated phenol, acrylamidomethylated phenolic novolac, and combinations thereof. These materials are further described in U.S. Pat. Nos. 4,903,440 and 5,236,472 (both to Kirk et al.).

Isocyanurate derivatives having at least one pendant acrylate group and isocyanate derivatives having at least one pendant acrylate group are further described in U.S. Pat. No. 4,652,274 (Boettcher et al.). An example of one isocyanurate material is triacrylate of tris(hydroxyethyl) isocyanurate.

Epoxy resins have one or more epoxy groups that may be polymerized by ring opening of the epoxy group(s). Such epoxy resins include monomeric epoxy resins and oligomeric epoxy resins. Examples of useful epoxy resins include, but are not limited to: 2,2-bis[4-(2,3-epoxypropoxy)-phenyl propane] (diglycidyl ether of bisphenol) and materials available as EPON 828, EPON 1004, and EPON 1001F from Shell Chemical Co. of Houston, Tex.; and DER-331, DER-332, and DER-334 from Dow Chemical Co. of Midland, Mich. Other suitable epoxy resins include glycidyl ethers of phenol formaldehyde novolac commercially available as DEN-431 and DEN-428 from Dow Chemical Co.

An example of particularly suitable polymeric binder resins of the present invention are acrylates. An example of a suitable acrylate includes, but is not limited to, trimethylolpropane triacrylate.

In one embodiment, the abrasive of the present invention includes between about 15 and about 60 wt % polymeric binder, particularly between about 25 and about 55 wt % polymeric binder, and more particularly between about 35 and about 45 wt % polymeric binder.

Solidification of the binder precursor can be achieved, for example, by curing (e.g., polymerization and/or cross-linking), by drying (e.g., driving off a liquid), and/or by cooling. Typically, the polymeric binder is prepared by crosslinking (e.g., at least partially curing and/or polymerizing) the binder precursor. During the manufacture of the structured abrasive article, the polymeric binder precursor is exposed to an energy source which aids in the initiation of polymerization (typically including crosslinking) of the binder precursor. Examples of suitable energy sources include, but are not limited to, thermal energy and radiation energy, which includes electron beam, ultraviolet light, and visible light. In the case of an electron beam energy source, a curative is not necessarily required because the electron beam itself generates free radicals. After this polymerization process, the binder precursor is converted into a solidified binder. Alternatively, for a thermoplastic binder precursor, during the manufacture of the abrasive article, the thermoplastic binder precursor is cooled to a degree that results in solidification of the binder precursor. Upon solidification of the binder precursor, the abrasive composite is formed.

A photointiator undergoes a photoreaction on absorption of light and can be used to cure the binder precursor of the abrasive agglomerate. Compounds that generate a free radical source if exposed to actinic electromagnetic radiation are generally termed photoinitiators. Examples of photoinitiators suitable in the present invention include benzoin and its derivatives such as alpha-methylbenzoin; alpha-phenylbenzoin; alpha-allylbenzoin; alpha-benzylbenzoin; benzoin ethers such as benzil dimethyl ketal (e.g., as commercially available as IRGACURE 651 from Ciba Specialty Chemicals of Tarrytown, N.Y.), benzoin methyl ether, benzoin ethyl ether, benzoin n-butyl ether; acetophenone and its derivatives such as 2-hydroxy-2-methyl-1-phenyl-1-propanone (e.g., as DAROCUR 1173 from Ciba Specialty Chemicals) and 1-hydroxycyclohexyl phenyl ketone (e.g., as IRGACURE 184 from Ciba Specialty Chemicals); 2-methyl-1-[4-(methylthio)phenyl]-2-(4-morpholinyl)-1-propanone (e.g., as IRGACURE 907 from Ciba Specialty Chemicals; 2-benzyl-2-(dimethylamino)-1-[4-(4-morpholinyl)phenyl]-1-butanone (e.g., as IRGACURE 369 from Ciba Specialty Chemicals). Other useful photoinitiators include, for example, pivaloin ethyl ether, anisoin ethyl ether, anthraquinones (e.g., anthraquinone, 2-ethylanthraquinone, 1-chloroanthraquinone, 1,4-dimethylanthraquinone, 1-methoxyanthraquinone, or benzanthraquinone), halomethyltriazines, benzophenone and its derivatives, iodonium salts and sulfonium salts, titanium complexes such as bis(eta.sub.5-2,4-cyclopentadien-1-yl)-bis[2,6-difluoro-3-(1H-pyrrol-1-yl)phenyl]titanium (e.g., as CGI 784DC from Ciba Specialty Chemicals); halonitrobenzenes (e.g., 4-bromomethylnitrobenzene), mono- and bis-acylphosphines (e.g., as IRGACURE 1700, IRGACURE 1800, IRGACURE 1850, and DAROCUR 4265 all from Ciba Specialty Chemicals). Combinations of photoinitiators may also be used. One or more spectral sensitizers (e.g., dyes) may be used in conjunction with the photoinitiator(s), for example, in order to increase sensitivity of the photoinitiator to a specific source of actinic radiation. An example of a particularly suitable photoinitiator includes, but is not limited to, phenylbis(2,4,6-trimethylbenzoyl)phosphine oxide (e.g., as IRGACURE 819 from Ciba Specialty Chemicals).

Epoxy resins can polymerize via a cationic mechanism with the addition of an appropriate cationic curing agent. Cationic curing agents generate an acid source to initiate the polymerization of an epoxy resin. These cationic curing agents can include a salt having an onium cation and a halogen containing a complex anion of a metal or metalloid. Other curing agents (e.g., amine hardeners and guanidines) for epoxy resins and phenolic resins may also be used.

Other cationic curing agents include a salt having an organometallic complex cation and a halogen containing complex anion of a metal or metalloid which are further described in U.S. Pat. No. 4,751,138 (Tumey et al.). Another example is an organometallic salt and an onium salt is described in U.S. Pat. No. 4,985,340 (Palazzotto et al.); U.S. Pat. No. 5,086,086 (Brown-Wensley et al.); and U.S. Pat. No. 5,376,428 (Palazzotto et al.). Still other cationic curing agents include an ionic salt of an organometallic complex in which the metal is selected from the elements of Periodic Group IVB, VB, VIB, VIM and VIIIB which is described in U.S. Pat. No. 5,385,954 (Palazzotto et al.).

Thermal initiators can also be used to cure the binder precursor and are initiated by heat. Examples of suitable free radical thermal initiators include peroxides, e.g., benzoyl peroxide and azo compounds. An example of a particularly suitable thermal initiator includes, but is not limited to, 2,2′-Azobis(2,4-dimethylvaleronitrile) polymerization initiator (VAZO 52 from Dupont).

The abrasive agglomerate may also include an adhesion promoter or coupling agent. To promote an association bridge between the binder and the ceria and filler, a silane coupling agent may be included in the slurry of ceria, filler and binder precursor; typically in an amount of from about 0.01 to about 5 wt %, particularly from about 0.01 to about 3 wt %, and more particularly from about 0.01 to about 1 wt %, although other amounts may also be used, for example depending on the size of the ceria and filler particles. Suitable silane coupling agents include, but are not limited to: methacryloxypropylsilane, vinyltriethoxysilane, vinyltris(2-methoxyethoxy)silane, 3,4-epoxycyclohexylmethyltrimethoxysilane, gamma-glycidoxypropyltrimethoxysilane, and gamma-mercaptopropyltrimethoxysilane (e.g., as available under the respective trade designations A-174, A-151, A-172, A-186, A-187, and A-189 from Witco Corp. of Greenwich, Conn.), allyltriethoxysilane, diallyldichlorosilane, divinyldiethoxysilane, and meta, para-styrylethyltrimethoxysilane (e.g., as commercially available under the respective trade designations A0564, D4050, D6205, and S 1588 from United Chemical Industries of Bristol, Pa.), dimethyldiethoxysilane, dihydroxydiphenylsilane, triethoxysilane, trimethoxysilane, triethoxysilanol, 3-(2-aminoethylamino)propyltrimethoxysilane, methyltrimethoxysilane, vinyltriacetoxysilane, methyltriethoxysilane, tetraethyl orthosilicate, tetramethyl orthosilicate, ethyltriethoxysilane, amyltriethoxysilane, ethyltrichlorosilane, amyltrichlorosilane, phenyltrichlorosilane, phenyltriethoxysilane, methyltrichlorosilane, methyldichlorosilane, dimethyldichlorosilane, dimethyldiethoxysilane, and mixtures thereof.

Grinding aids, which may optionally be included in the binder precursor, encompass a wide variety of different materials including both organic and inorganic compounds. A sampling of chemical compounds effective as grinding aids includes waxes, organic halide compounds, halide salts, metals and metal alloys. Specific waxes effective as a grinding aid include specifically, but not exclusively, the halogenated waxes tetrachloronaphthalene and pentachloronaphthalene. Other effective grinding aids include halogenated thermoplastics, sulfonated thermoplastics, waxes, halogenated waxes, sulfonated waxes, and mixtures thereof. Other organic materials effective as a grinding aid include specifically, but not exclusively, polyvinylchloride and polyvinylidene chloride. Examples of halide salts generally effective as a grinding aid include sodium chloride, potassium cryolite, sodium cryolite, ammonium cryolite, potassium tetrafluoroborate, sodium tetrafluoroborate, silicon fluorides, potassium chloride, and magnesium chloride. Halide salts employed as a grinding aid typically have an average particle size of less than 100 mm, with particles of less than 25 mm preferred. Examples of metals generally effective as a grinding aid include antimony, bismuth, cadmium, cobalt, iron, lead, tin, and titanium. Other commonly used grinding aids include sulfur, organic sulfur compounds, graphite, and metallic sulfides. Combinations of these grinding aids can also be employed.

In one embodiment, the abrasive agglomerates are formed as precisely shaped agglomerate particles or structured abrasives, and particularly micro-replicated structured abrasives. In one embodiment, the structured abrasives are precision shaped grains (PSG). For example, precisely shaped particles may be any three-dimensional shape such as a pyramid, cone, block, cube, sphere, cylinder, rod, triangle, hexagon, square, and the like. In addition, any combination of shapes of abrasive agglomerates may be used in the present invention.

The abrasive agglomerates of the present invention must be hard enough to sufficiently clean a glass surface while minimizing any scratching of the surface and also polishing the surface. One measurement of hardness is through the Mohs' scale of mineral hardness. The Mohs' scale of hardness characterizes the scratch resistance of a mineral through the ability of harder material to scratch a softer material. In one embodiment, the ceria in the abrasive agglomerates used in the present invention has a Mohs hardness of between about 6.0 and about 7.0. In one embodiment, to counter the higher Mohs hardness of ceria and reduce the overall hardness of the abrasive agglomerate, the filler generally has a Mohs hardness of about 3.

The hardness of the abrasive agglomerate and the geometry of the cured features also affect the scouring performance and wear of the abrasive agglomerate. The geometry of the cured features is generally fixed by the shape of the tool. The hardness of the abrasive agglomerate can be affected by various factors: extent of cure, inherent hardness of the polymer matrix, presence of hard minerals, adhesion of minerals to the polymer matrix, and presence of local-hardness-enhancing additives such as sub-micron mineral particles. Many factors that enhance soil removal (scouring) may also enhance the durability of the abrasive agglomerate.

In practice, to make the fixed abrasive of the present invention, the abrasive agglomerates are printed onto an appropriate backing and then laminated or otherwise attached to a substrate. When the abrasive agglomerates are precisely shaped, the abrasive agglomerates may be generally made by forming a slurry mixture containing at least the binder precursor, cerium oxide, and filler and coating the mixture into precisely shaped cavities of a production tool, at least partially curing the binder precursor, and then removing the precisely shaped particles from the cavities of the production tool. The mixture can be formed using any conventional technique such as high shear mixing, air stirring, or tumbling. A vacuum can also be used during mixing so as to minimize air entrapment. The mixture may be introduced into the cavities of the production tool using techniques such as gravity feeding, pumping, die coating, or vacuum drop die coating.

The slurry is then contacted with a backing and the binder precursor (e.g., by exposure to an energy source) is at least partially cured in a manner such that the resulting structured abrasive article has a plurality of shaped abrasive composites affixed to the backing. Examples of useful backings include films, foams (open cell or closed cell), papers, foils, and woven or non-woven fabrics. The backing may be, for example, a thermoplastic film that includes a thermoplastic polymer, which may contain various additive(s). Suitable thermoplastic polymers include, for example, polyolefins (e.g., polyethylene, and polypropylene), polyesters (e.g., polyethylene terephthalate), polyamides (e.g., nylon-6 and nylon-6,6), polyimides, polycarbonates, polyurethanes, and combinations and blends thereof. Examples of suitable additives include colorants, processing aids, reinforcing fibers, heat stabilizers, UV stabilizers, and antioxidants. Examples of useful fillers include clays, calcium carbonate, glass beads, talc, clays, mica, wood flour; and carbon black. The backing may be a composite film, for example a coextruded film having two or more discrete layers.

In one embodiment, the average thickness of the backing is in a range of from at least about 1 mil (25 micrometers) to about 100 mils (2500 micrometers), although thicknesses outside of this range may also be used.

The backing including the abrasive agglomerates can be attached to the substrate by any means known in the art, including, but not limited to, a pressure-sensitive adhesive, a hooked film, or a looped fabric. Useful pressure-sensitive adhesives (PSAs) include, for example, hot melt PSAs, solvent-based PSAs, and latex-based PSAs. Pressure-sensitive adhesives are widely commercially available; for example, from 3M Company of Saint Paul, Minn. Examples of energy sources include, but are not limited to, thermal energy and radiant energy (including electron beam, ultraviolet light, and visible light). In one embodiment, the substrate may be a nonwoven, foam, sponge, or plastic.

In one embodiment, a slurry of ceria and filler in the binder precursor is coated directly onto a production tool having precisely-shaped cavities therein and brought into contact with the backing or coated on the backing and brought to contact with the production tool. In this embodiment, the slurry is typically then solidified (e.g., at least partially cured) while it is present in the cavities of the production tool.

The production tool can be a belt, a sheet, a continuous sheet or web, a coating roll such as a rotogravure roll, a sleeve mounted on a coating roll, or die. The production tool can be composed of metal (e.g., nickel), metal alloys, or plastic. The metal production tool can be fabricated by any conventional technique such as, for example, engraving, bobbing, electroforming, or diamond turning. A thermoplastic tool can be replicated off a metal master tool. The master tool will have the inverse pattern desired for the production tool. The master tool can be made in the same manner as the production tool. The master tool is preferably made out of metal, e.g., nickel and is diamond turned. The thermoplastic sheet material can be heated and optionally along with the master tool such that the thermoplastic material is embossed with the master tool pattern by pressing the two together. The thermoplastic can also be extruded or cast onto the master tool and then pressed. The thermoplastic material is cooled to solidify and produce the production tool. Examples of thermoplastic production tool materials include polyester, polycarbonates, polyvinyl chloride, polypropylene, polyethylene and combinations thereof. If a thermoplastic production tool is utilized, then care should typically be taken not to generate excessive heat that may distort the thermoplastic production tool.

The production tool may also contain a release coating to permit easier release of the abrasive article from the production tool. Examples of such release coatings for metals include hard carbide, nitrides or borides coatings. Examples of release coatings for thermoplastics include, but are not limited to, silicones and fluorochemicals.

Additional details concerning methods of manufacturing structured abrasive articles having precisely-shaped abrasive composites may be found, for example, in U.S. Pat. No. 5,152,917 (Pieper et al.); U.S. Pat. No. 5,435,816 (Spurgeon et al.); U.S. Pat. No. 5,672,097 (Hoopman); U.S. Pat. No. 5,681,217 (Hoopman et al.); U.S. Pat. No. 5,454,844 (Hibbard et al.); U.S. Pat. No. 5,851,247 (Stoetzel et al.); and U.S. Pat. No. 6,139,594 (Kincaid et al.).

When the abrasive agglomerates are not precisely shaped, a supersize coating may be coated onto the surface of the abrasive agglomerates disposed on the backing. The optional supersize, if present, is disposed on at least a portion of the fixed abrasive. For example, a supersize may be disposed only on the shaped abrasive agglomerates (e.g., on their grinding surfaces), although it may also be disposed on the channels. Examples of supersizes include one or more compounds selected from the group consisting of secondary grinding aids such as alkali metal tetrafluoroborate salts, metal salts of fatty acids (e.g., zinc stearate or calcium stearate), and salts of phosphate esters (e.g., potassium behenyl phosphate), phosphate esters, urea-formaldehyde resins, mineral oils, crosslinked silanes, crosslinked silicones, and/or fluorochemicals; fibrous materials; antistatic agents; lubricants; surfactants; pigments; dyes; coupling agents; plasticizers: antiloading agents; release agents; suspending agents; rheology modifiers; curing agents; and mixtures thereof. A secondary grinding aid is preferably selected from the group of sodium chloride, potassium aluminum hexafluoride, sodium aluminum hexafluoride, ammonium aluminum hexafluoride, potassium tetrafluoroborate, sodium tetrafluoroborate, silicon fluorides, potassium chloride, magnesium chloride, and mixtures thereof. In some embodiments, one or more metal salts of fatty acids (e.g., zinc stearate) may be usefully included in the supersize.

When used as a fixed abrasive, the abrasive agglomerates have been found to be effective at scouring common household soils from glass stove-tops. The resulting fixed abrasive can efficiently and effectively clean a surface with minimal to no scratching of the surface. In addition, by incorporating the cerium oxide into the abrasive agglomerates, it is possible to heal superficial surface scratches such as those causing a hazy, aged appearance on, for example, stove-tops having a glass surface. The cerium oxide effectively removes shallow microscratches that cause haziness in glass surfaces. Cerium oxide particle size, shape, detailed thermal history and chemical makeup, especially at the particle surface, are believed to affect the rate of glass removal. In addition, the abrasive agglomerate of the present invention is able to polish glass and glass-ceramic surfaces only in the presence of water and does not require a polishing solution.

Although the present invention has been described with reference to preferred embodiments, workers skilled in the art will recognize that changes may be made in form and detail without departing from the spirit and scope of the invention.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

### Materials

| Trade name | Material description | Source/Supplier |
|---|---|---|
| SR351H | Acrylate 1 - Trimethylolpropane | Sartomer USA LLC, Exton, PA, |
| | triacrylate | USA. |
| SR36D | Acrylate 2 - 70% Trimethylolpropane | Sartomer USA LLC, Exton, PA, |
| | triacrylate blended with 30% | USA. |
| | tris (2-hydroxy ethyl) isocyanurate | |
| | triacrylate | |
| BYK-W985 | Dispersant 1 - 10% solution of an | BYK USA Inc., Wallingford, CT, |
| | acidic polyester | USA |
| Solplus D520 | Dispersant 2 - Acidic phosphate | Lubrizol Advanced Materials |
| | polyester dispersant which was a liquid | Cleveland, OH, USA |
| | with 90-100% actives, | |
| Irgacure 819 | Photoinitiator - Phenylbis(2,4,6- | BASF CORP., Florham Park, NJ, |
| | trimethylbenzoyl)phosphine oxide | USA. |
| Hubercarb | Filler 1 - Calcium carbonate with | Huber Engineered Materials, Atlanta, |
| Q325 | amedian particle size of 13 μm and | GA, USA |
| | with a purity of 96.5% | |
| Hubercarb | Filler 2 - Calcium carbonate with a | Huber Engineered Materials, Atlanta, |
| W3N | median particle size of 2.8 μm and | GA, USA |
| | with a purity of 99.3% | |
| Socal 31 | Filler 3- Calcium carbonate with a | Imerys Group, Paris, France |
| | median particle size of less than0.3 | |
| | μm and with a purity equal to or higher | |
| | than 98% CaCO₃ | |
| 00630-M | Mineral 1 - Cerium oxide with a total | PIDC, Inc., Ann Arbor, MI USA |
| | rare earth oxide content of 99.9% | |
| Cerox 1670 | Mineral 2 - Cerium oxide with a | Solvay SA, Brussels, Belgium. |
| | particle size range of 1 to 2 microns | |
| | and with a tap density of 1.5 - 1.9. | |
| REACTINT | Colorant - A green polymeric colorant | Milliken & Company, Spartanburg, |
| GREEN | | SC, USA |
| 1915 | | |
| Non-Scratch | Comparative Pad 1 - Scotch-Brite ™ | 3M Company, St. Paul, MN, USA |
| scour pad | Non-Scratch Scour Pad, commercially | |
| | available under the catalog number | |
| | 623-12 | |
| Heavy-Duty | Comparative Pad 2 - Scotch-Brite ™ | 3M Company, St. Paul, MN, USA |
| scour pad | Non-Scratch Scour Pad, commercially | |
| | available under the catalog number | |
| | 220 | |

### Preparation of Abrasive Slurries

Photocurable slurries of the invention were prepared as described below. All ingredients were weighed out to the nearest 0.01 gram in plastic beakers or jars and were mixed using a Speedmixer DAC 400.1 (Flack Tek, Inc., Landrum, S.C., USA) for 4 min at 1000 rpm. The slurry formulations (FM) are provided in Table 1.

TABLE 1

| | FM 1 | FM 2 | FM 3 | FM 4 | FM 5 | FM 6 |
|---|---|---|---|---|---|---|
| Components | wt (%) | wt (%) | wt (%) | wt (%) | wt (%) | wt (%) |
| Acrylate 1 | 38.61 | 38.61 | 38.61 | 38.61 | 38.61 | 38.61 |
| Acrylate 2 | 0 | 0 | 0 | 0 | 0 | 0 |
| Dispersant 1 | 0.6 | 0 | 0.6 | 0.6 | 0.6 | 0.6 |
| Dispersant 2 | 0 | 0.60 | 0 | 0 | 0 | 0 |
| Filler 1 | 39.9 | 39.9 | 54.9 | 47.9 | 29.9 | 39.9 |
| Filler 2 | 0 | 0 | 0 | 0 | 0 | 0 |
| Filler 3 | 0 | 0 | 0 | 0 | 0 | 0 |
| Mineral 1 | 20 | 20 | 5 | 12 | 30 | 0 |
| Mineral 2 | 0 | 0 | 0 | 0 | 0 | 20 |
| Photoinitator | 0.79 | 0.79 | 0.79 | 0.79 | 0.79 | 0.79 |
| Colorant | 0.1 | 0.1 | 0.1 | 0.1 | 0.1 | 0.1 |

| | FM 7 | FM 8 | FM 9 | FM 10 |
|---|---|---|---|---|
| Components | wt (%) | wt (%) | wt (%) | wt (%) |
| Acrylate 1 | 38.61 | 38.61 | 0 | 39.21 |
| Acrylate 2 | 0 | 0 | 38.61 | 0 |
| Dispersant 1 | 0.6 | 0.6 | 0.6 | 0 |
| Dispersant 2 | 0 | 0 | 0 | 0 |
| Filler 1 | 34.9 | 0 | 39.9 | 39.9 |
| Filler 2 | 0 | 39.9 | 0 | 0 |
| Filler 3 | 5 | 0 | 0 | 0 |
| Mineral 1 | 20 | 0 | 0 | 0 |
| Mineral 2 | 0 | 20 | 20 | 20 |
| Photoinitator | 0.79 | 0.79 | 0.79 | 0.79 |
| Colorant | 0.1 | 0.1 | 0.1 | 0.1 |

Mixtures were coated and cured within four hours after mixing.

### Textured Tool

A textured tool, the texture being an array of cavities, was used to prepare the structured abrasives. The cavities of the polypropylene tool were truncated, square pyramids having a depth of 180 micrometers, a base with dimensions of 250 by 250 micrometers, and a distal end with dimensions of 150 by 150 micrometers. The cavities were in a square grid array with a pitch, i.e. center to center distance between cavities, of 375 micrometers. The lateral sides forming the cavities were tapered with diminishing width toward the distal end so that the conglomerate abrasive particles were easily removed from the tooling. The textured polypropylene tooling was formed by an embossing process, wherein the texture from a metal master tool, having the inverse texture of the desired polypropylene sheet, was formed into the polypropylene. The pyramidal array of the master tool was made by a conventional diamond turning process of a metal. Embossing of the polypropylene sheet via the master tool was conducted near the melting temperature of the polypropylene following conventional embossing techniques. The tooling was essentially the inverse of the desired shape, dimensions and arrangement of the abrasive composites.

### Examples 1-10

Approximately 40 grams of the abrasive slurry was coated into the cavities of 30 cm×30 cm sheet of textured polypropylene tooling using a rubber squeegee such that the abrasive slurry completely filled the cavities and the excess slurry was removed by a doctor blade. Next, 0.127 millimeter (3 mil) thick primed polyester (PET) backing was brought into contact with the abrasive slurry contained in the cavities of the tooling. The backing, abrasive slurry, and tooling secured to the metal carrier plate were passed through a bench top laboratory laminator (Model #001998, ChemInstruments, Fairfield, Ohio, USA). The article was continuously fed between two rubber rollers at a pressure of about 210-420 Pa (30-60 psi) and a speed of about 1 cm/sec. Pressure adjustments were made depending on the general quality of the coating. A quartz plate about 6.3 mm (¼ inch) thick was then placed on top of the backing covering the entire backing. The article was cured by passing the metal carrier plate, tooling, abrasive slurry, backing, and quartz plate under two ultraviolet light lamps (“V” bulb, available from Fusion Systems Inc., Lombard, Ill., USA) that operated at about 157.5 Watts/cm (400 Watts/inch). The radiation passed through the quartz plate and PET backing. The speed was about 4.4 meters/minute (15 feet/minute) and the sample was passed under the lamps twice at the identical process conditions. The abrasive article was removed from the production tooling by gently pulling on the PET backing.

### Test Methods

### Scouring Test:

Glass plates with approximate dimensions of 10 cm×10 cm×0.4 cm, commercially available from Sigma-Aldrich Corp. (St. Louis, Mo., USA) under the trade name CVS10 GLASS PLATE, which were used as-received without any surface treatment and cleaning, were placed on a laboratory bench. Approximately 20 grams of marinara sauce (commercially available under the trade designation of Prego Italian Sauce Marinara from Campbell Soup Company, Inc., Camden, N.J., USA) were placed on the glass plate. The glass plate with the marinara sauce was then placed on a laboratory hot plate (commercially available from VWR, Inc., Radnor, Pa., USA) and the temperature setting of the hot plate was turned to 200° C. After about 10 minutes, a hardened stain was observed on the glass plate. The glass plate was removed from the hot plate and left on a laboratory bench at ambient temperature for approximately 24 hours before scouring testing.

Before the scouring test, a drop of tap water was placed on the stained-glass plate. The abrasive to be tested was moved back and forth for 30 seconds on the stained-glass plate by applying light hand pressure. After 30 seconds, the removed extent of the stain was rinsed under running water and extent of removal was visually evaluated as follows. A sample that resulted in a scouring rating of 3 was considered to pass the scouring removal test.

| Rating | Description |
|---|---|
| 1 | The tested abrasive was not able to |
| | remove significant extent of stain |
| | from the glass surface and no |
| | see-through section was created. |
| 2 | The tested abrasive only removed |
| | limited extent of the stain and only |
| | partially see-through sections were created. |
| 3 | The tested abrasive removed the |
| | stain from the glass surface and |
| | created a continuous see-through |
| | section on the stained-glass surface. |

### Scratch Test

Glass plates with approximate dimensions of 10 cm×10 cm×0.4 cm commercially available from Sigma-Aldrich Corp. (St. Louis, Mo., USA) under the trade name CVS10 GLASS PLATE, which were used as-received without any surface treatment and cleaning, were placed on a laboratory bench. Abrasives to be tested were moved back and forth for 30 seconds on the glass plate by applying light hand pressure. After 30 seconds, the abrasive was removed and the plate was visually observed for scratching, as follows. A sample that resulted in a rating of 3 was considered to pass the scratch test.

| Rating | Description |
|---|---|
| 3 | No scratches were visible. |
| 2 | Some scratches were visible. |
| 1 | Easily visible scratch pattern with |
| | well-defined scratch patterns wasvisible |

### Scratch Removal Test

Glass plates with approximate dimensions of 10 cm×10 cm×0.4 cm, commercially available from Sigma-Aldrich Corp., St. Louis, Mo. under the trade name CVS10 GLASS PLATE, which were used as-received without any surface treatment and cleaning, were placed on a laboratory bench. Comparative pad 2 was moved back and forth for 30 seconds on the glass plate by applying light hand pressure. After 30 seconds, the pad was removed and the plate was rinsed under running water. It was observed that the comparative pad created scratching on the surface.

Before the scratch removal test, a drop of tap water was placed on the scratched glass plate. The abrasive to be tested was moved back and forth for 30 seconds on the scratch glass plate by applying light hand pressure. After 30 seconds, the abrasive was removed, the plate was rinsed under running water and dried with a paper towel. The extent of scratch removal was visually evaluated as follows. A sample that resulted in a rating of 2 was considered to pass the scratch removal test.

| Rating | Description |
|---|---|
| 5 | Scratches removed and no visible scratches left. |
| 4 | Most scratches were removed and very light scratches remained. |
| 3 | Some light scratches were visible. |
| 2 | Scratches are light, but more visible |
| | with well-defined scratch patterns. |
| 1 | Easily visible scratch pattern covering entire |
| | area with well-defined scratch patterns. |

Results are reported in Table 2.

TABLE 2

| | Scouring | Scratch | Scratch |
|---|---|---|---|
| | Test | Test | Removal Test |
| Comparative pad 1 | 1 | 3 | 1 |
| Comparative pad 2 | 3 | 1 | 1 |
| Example 1 | 3 | 3 | 3 |
| Example 2 | 3 | 3 | 2 |
| Example 3 | 3 | 3 | 1 |
| Example 4 | 3 | 3 | 2.5 |
| Example 5 | 3 | 3 | 4 |
| Example 6 | 3 | 3 | 4 |
| Example 7 | 3 | 3 | 4 |
| Example 8 | 3 | 3 | 4 |
| Example 9 | 3 | 3 | 2.5 |
| Example 10 | 3 | 3 | 3 |

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. The present invention may suitably comprise, consist of, or consist essentially of, any of the disclosed or recited elements. As used herein, the term “consisting essentially of” does not exclude the presence of additional materials which do not significantly affect the desired characteristics of a given composition or product. In particular, any of the elements that are positively recited in this specification as alternatives, may be explicitly included in the claims or excluded from the claims, in any combination as desired. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. An abrasive agglomerate comprising:
between about 8 and about 50 wt % cerium oxide;
between about 5 and about 75 wt % filler; and
a curable, polymeric binder resin.

2. The abrasive agglomerate of claim 1, wherein the abrasive agglomerate comprises between about 15 and about 60 wt % curable, polymeric binder resin.

3. The abrasive agglomerate of claim 1, wherein the curable, polymeric binder resin comprises an acrylate.

4. The abrasive agglomerate of claim 1, wherein the abrasive agglomerate comprises between about 10 and about 25 wt % cerium oxide.

5. The abrasive agglomerate of claim 1, wherein the abrasive agglomerate comprises between about 20 and about 60 wt % filler.

6. The abrasive agglomerate of claim 1, wherein the filler comprises salts of group II metals or transition metals that have some solubility in tap water.

7. The abrasive agglomerate of claim 1, wherein the filler comprises one of a sulfate, chloride, acetate, or carbonate salt of calcium.

8. The abrasive agglomerate of claim 1, wherein the filler is calcium carbonate.

9. The abrasive agglomerate of claim 1, wherein the abrasive agglomerate comprises precisely shaped agglomerate particles or structured abrasives.

10. The abrasive agglomerate of claim 1, wherein the cerium oxide has a Mohs hardness of between about 6.0 and about 7.0.

11. The abrasive agglomerate of claim 1, wherein the filler has a Mohs hardness of about 3.0.

12. A fixed abrasive comprising:
a backing; and
an abrasive agglomerate fixed to the backing,
wherein the abrasive agglomerate comprises:
between about 8 and about 50 wt % cerium oxide;
between about 5 and about 75 wt % filler; and
a curable, polymeric binder resin.

13. The fixed abrasive of claim 12, further comprising a substrate adjacent the backing.

14. The fixed abrasive of claim 12, wherein the curable, polymeric binder resin comprises an acrylate.

15. The fixed abrasive of claim 12, wherein the abrasive agglomerate comprises between about 10 and about 25 wt % cerium oxide.

16. The fixed abrasive of claim 12, wherein the filler comprises salts of group II metals or transition metals that have some solubility in tap water.

17. The fixed abrasive of claim 12, wherein the abrasive agglomerate comprises precisely shaped agglomerate particles or structured abrasives.

18. The fixed abrasive of claim 12, wherein the cerium oxide has a Mohs hardness of between about 6.0 and about 7.0.

19. The fixed abrasive of claim 12, wherein the filler has a Mohs hardness of about 3.0.

20. An abrasive article, comprising the fixed abrasive of claim 12.
